(19) United States
(12) Patent Application Publication
(10) Pub. No.: US 2005/0041807 A1
(43) Pub. Date: Feb. 24, 2005

(54) Display apparatus having lock operation for external input and method of implementing lock operation

(76) Inventor: Sung-tae Lee, Suwon-si (KR)

Correspondence Address: STANZIONE & KIM, LLP, 1740 N STREET, N.W., FIRST FLOOR, WASHINGTON, DC, 20036, US

(21) Appl. No.: 10/902,182

(22) Filed: Jul. 30, 2004

(30) Foreign Application Priority Data
Aug. 4, 2003 (KR) 2003-53887

(51) Int. Cl. H04N 7/167

(52) U.S. Cl. 380/232

(57) ABSTRACT

A display apparatus having a lock function for an external input and a method of implementing the lock operation to prevent teenagers from viewing inappropriate videos by setting the lock operation when changing an input signal. The method of implementing the lock operation for the external input includes receiving and storing a password as a first password used for setting the lock operation to be performed when changing the input signal, requesting that a password be input as a second password whenever a change of the input signal is required, to determine whether the input second password and the stored first password are the same, and changing the input signal if the input second password and the stored first password are the same, to display an image corresponding to the changed input signal. The present general inventive concept prevents teenagers from viewing inappropriate videos by changing an input signal only if the input second password and the stored first password are the same when the change of the input signal is requested.

### CROSS-REFERENCE TO RELATED APPLICATIONS

This application claims the priority of Korean Patent Application No. 2003-53887, filed on Aug. 4, 2003, in the Korean Intellectual Property Office, the disclosure of which is incorporated herein in its entirety by reference.

### BACKGROUND OF THE INVENTION

1. Field of the Invention

The present general inventive concept relates to a display apparatus and method, and more particularly, to a display apparatus having a lock operation for an external input and a method of implementing the lock operation to prevent teenagers from viewing inappropriate videos by setting the lock operation when changing an input signal.

2. Description of the Related Art

Televisions (TVs) supply users with image information which is sent through satellite, cable, and terrestrial broadcasters, stored in information storage devices such as built-in hard disks, and recorded in predetermined recording media. Furthermore, information supply and information search can be provided by connecting a TV to a communication network, such as Internet.

Most TVs include video interfaces to which video signal inputs are connected. When a user is watching a video produced by a video signal received through a video interface and wants to watch another video produced by another video signal received through another video interface, the user changes an input/output path of the video signal by accessing an on-screen-display (OSD) with a television keyboard or a remote controller.

When a user changes the video interface with a conventional remote controller, there are no limitations on the input source, for example, a PC signal, a video signal, an s-video signal, a TV signal, etc. Therefore, children can view films for amusement, films of violence, and information with adult content.

### SUMMARY OF THE INVENTION

In order to solve the above and/or other problems, it is an aspect of the present general inventive concept to provide a display apparatus having a lock function (locking operation) for an external input and a method of implementing the lock function (locking operation) to prevent teenagers from watching inappropriate videos by setting the lock function when changing an input signal.

Additional aspects and advantages of the present general inventive concept will be set forth in part in the description which follows and, in part, will be obvious from the description, or may be learned by practice of the general inventive concept.

The above and/or other aspects of the present general inventive concept may be achieved by providing a display apparatus having a lock function for an external input, the apparatus including a video interface unit which receives an input signal from an external source providing a plurality of input signals and selectively changes the input signal by a control signal, a signal processor which processes the input signal such that an image corresponding to the input signal can be displayed, and a controller which receives and stores a first (reference) password to be used for setting a lock function to be performed when changing the input signal, requests that a second password be input whenever a change of the input signal is requested, and outputs the control signal to the video interface unit to change the input signal when the input second password and the stored first password are the same.

According to an aspect of the present general inventive concept, the controller stores the first password in an administrator field that only an administrator can access.

According to another aspect of the present general inventive concept, the controller requests that a password be input as the second password up to a predetermined number of times until the input second password and the stored first password are the same whenever the change of the input signal is requested, to determine whether any of the input passwords and the stored first password are the same.

According to yet another aspect of the present general inventive concept, the input signal is not changed if the input second password and the stored first password are not the same for any of the predetermined number of times that a password is requested as the second password.

According to still another aspect of the present general inventive concept, the controller displays an image produced by a previous input signal input before the display apparatus is turned off if the input second password and the stored first password are not the same whenever the change of the input signal is requested, and the display apparatus is turned off and then on.

According to another aspect of the present general inventive concept, the controller resets the first password only by the administrator if a user forgets the stored first password.

The above and/or other aspects of the present general inventive concept may also be achieved by providing a method of implementing a lock function in a display device, the method including receiving and storing a first (reference) password used for setting a lock function to be performed when changing an input signal, requesting that a second password be input whenever a change of the input signal is required, to determine whether the input second password and the stored first password are the same, and changing the input signal if the input second password and the stored first password are the same and displaying an image corresponding to the updated (changed) input signal.

According to an aspect of the present general inventive concept, the method may further include requesting that a password be input as the second password up to a predetermined number of times until the input second password and the stored first password are the same, to determine whether the input second password and the stored first password are the same each time.

According to another aspect of the present general inventive concept, the input signal is not changed if the input password and the stored password are not the same for any of the predetermined number of times that the password is requested.

According to yet another aspect of the present general inventive concept, an image produced by a previous input signal input before the display apparatus is turned off is displayed if the input second password and the stored first password are not the same whenever a change of the input signal is requested, and the display apparatus is turned off and then on.

According to still another aspect of the present general inventive concept, the first password is recorded in an administrator field that only an administrator can access.

According to another aspect of the present general inventive concept, the first password is reset by the administrator if a user forgets the first password.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a display apparatus having a lock function for an external input according to an embodiment of the present general inventive concept;

FIG. 2 is an on-screen-display (OSD) menu output to a display unit to set a lock function and to implement the lock function in the display apparatus of FIG. 1; and

FIG. 3 is a flowchart illustrating a method of implementing a lock function (operation) for an external input according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

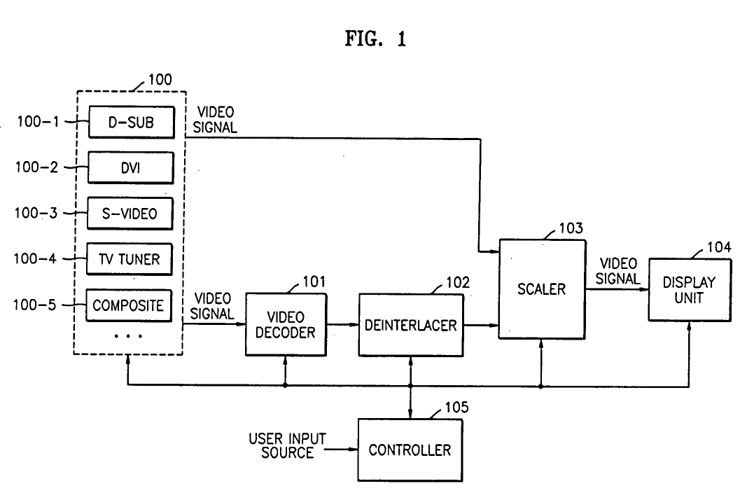

FIG. 1 is a block diagram illustrating a display apparatus having a lock function for an external input according to an embodiment of the present general inventive concept.

The display apparatus may include a video interface unit 100, a video decoder 101, a deinterlacer 102, a scaler 103, a display unit 104, and a controller 105.

The video interface unit 100 may include a D-SUB connector 100-1, a digital video interactive (DVI) connector 100-2, a separate (S) video connector 100-3, a TV tuner connector 1004, and a composite connector 100-5. The video decoder 101, the deinterlacer 102, and the scaler 103 can be included in a signal processor.

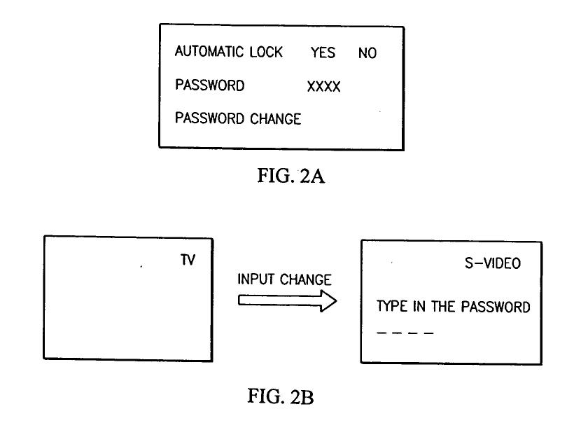

FIG. 2A is an on-screen-display (OSD) menu output to the display unit 104 to set a lock function. FIG. 2B is the on-screen-display (OSD) menu output to the display unit 104 to implement the lock function.

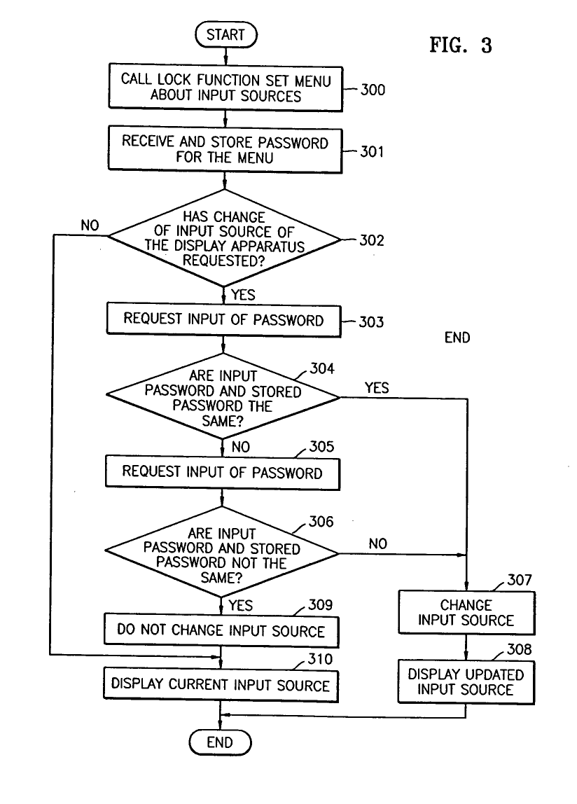

FIG. 3 is a flowchart illustrating a method of implementing a lock function in a display apparatus according to another embodiment of the present invention.

The display method may include calling a lock function set menu in operation 300, receiving and storing a first (reference) password for the menu in operation 301, determining whether a change of an input source of the display apparatus has been requested in operation 302, requesting an input of a second password in step 303, determining whether the input password and the stored password are the same in operation 304, requesting another input of a password as the second password in operation 305, determining whether the input second password and the stored first password are not the same in operation 306, changing the input source in operation 307, displaying the changed input source in operation 308, preventing the input source from being changed in operation 309, displaying the current input source in operation 310.

The display apparatus having the lock function for the external input according to the embodiment of the present general inventive concept will now be described with reference to FIGS. 1 and 2.

The video interface unit 100 can receive input signals from external devices. The video interface unit 100 can receive only the input signals selected by a control signal of the controller 105. In this embodiment of the present general inventive concept, the video interface unit 100 can receive input sources transmitted from three external devices (a PC, a game device, and a TV). However, the number of the external devices is not limited to 3.

The video interface unit 100 can receive first video signals transmitted from the PC (not shown) through the D-Sub connector 100-1 and the DVI connector 100-2. The video interface unit 100 can also receive second video signals transmitted from the game device (not shown) through the S-video connector 100-3 as an S-video signal. The S-video signal may include a luminance (Y) signal and a chroma (C) signal. The C signal may include two chrominance signals produced from a component signal using a phase modulation method. In the S-video signal, the Y signal and the C signal can be separated from a composite signal. S-videos can produce high quality videos more efficiently than composite videos. Usually, a connector including four pins can be connected to the S-video connector 100-3 through a dedicated line to receive the S-video signal. The video interface unit 100 can receive third video signals transmitted from the TV (not shown) through the TV tuner connector 100-4 and the composite connector 100-5.

The first video signals transmitted from the PC through the D-Sub connector 100-1 and the DVI connector 100-2 can be output directly to the scaler 103. However, the second video signal transmitted from the game device through the S-video connector 100-3 and the third video signals transmitted from the TV through the TV tuner connector 100-4 and the composite connector 100-5 can be output to the video decoder 101.

The video decoder 101 can decode the second and third video signals transmitted through the S-video connector 100-3, the TV tuner connector 100-4 and the composite connector 100-5 of the video interface unit 100, respectively, and can output the decoded video signals to the deinterlacer 102.

The deinterlacer 102 can deinterlace the decoded video signals and can output the deinterlaced signal to the scaler 103.

The scaler 103 can convert a resolution of the first video signals and the deinterlaced signals corresponding to the first, second, and third video signals to another resolution suitable for the display unit 104, can adjust video quality settings, and can output the converted signals to the display unit 104.

The controller 105 can receive and store a first (reference) password for setting the lock function to limit an ability to change the input sources, can request a second password to be input when changing the input sources, and can output a control signal to the video interface unit 100 to change the input signals when the input second password and the stored first password are the same.

A first user can call a menu to set the lock function to be performed when changing the input sources using the controller 105. FIG. 2A illustrates an OSD menu output to the display unit 104 to set the lock function. The first user can input the first password to set the lock function to be performed when changing the input sources. The controller 105 can store the first password input by the first user in an administrator field that only an administrator can access. The first user can change the first password by calling the OSD menu illustrated in FIG. 2A.

After the password is set, the OSD menu illustrated in FIG. 2B can be displayed by the display unit 104 when the input source is changed. The controller 105 can request a password to be input as the second password to unlock the lock function when the input sources are changed. Then, the first user can input a password as the second password, and the controller 105 can compare the input second password and the first password stored in the administrator field. If the input second password and the first password stored in the administrator field are the same, the input source can be successfully changed, and the updated (changed) input signal can be input to the display unit 104.

However, if, for example, a second user requests to receive S-video signals (second video signals) input from the game device through the S-video connector 100-3 while watching video signals (third video signals) input from the TV through the TV tuner connector 100-4, the OSD menu requesting a password as the second password as illustrated in FIG. 2B can be displayed to allow the second user to input the password as the second password. The controller 105 can compare the input second password and the first password stored in the administrator field to determine if the input second password and the first password stored in the administrator field are the same, the input source can be changed from the TV to the game device, and the updated (changed) input signal is input to the display unit 104.

However, if the input second password and the first password stored in the administrator field are not the same, the controller 105 can request that another password be input as the second password a predetermined number of times. The controller 105 does not change the input signal if the input second passwords and the stored first password are not the same.

For example, if the second user selects the change of the input source in order to receive the S-video signals (second video signals) input from the game device through the S-video connector 100-3 while watching the third video signals input from the TV through the TV tuner connector 100-4, the OSD menu illustrated in FIG. 2B can be displayed and the second user can input a password as the second password. The controller 105 can compare the input second password and the first password stored in the administrator field and, if the input second password and the first password stored in the administrator field are not the same, the input signal can be not changed.

If the input second password and the first password stored in the administrator field are not the same, even though the display apparatus has been turned off and then on again, a password can be requested again as the second password or the image produced by a previous input source input before the display apparatus was turned off is displayed.

If the first user forgets the first password which has been stored in the administrator field or the first password is exposed to the second user, the administrator can set a new password as the first (reference) pasword.

Finally, with reference to FIGS. 1, 2 and 3, a method of implementing a lock function according to the embodiment of the present general inventive concept will now be described.

Whenever the input sources are changed, the first user can call the lock function set menu in operation 300. The OSD menu to be displayed when the lock function set menu is called can be stored in the controller 105.

Using the OSD menu illustrated in FIG. 2A, the first user can input a password as the first (reference) password, and the controller 105 can store the first password in an administrator field in operation 301. The first user can input the first password to set the lock function to be performed when changing the input sources. The controller 105 can store the first password input by the first user in the administrator field that only the administrator can access. The first user (administrator) can change the first password by calling the OSD menu illustrated in FIG. 2A.

The controller 105 can determine whether a change of the input source has been requested, in operation 302. If the change of the input source has been requested, a password is requested to be input as the second password in operation 303. Whenever the change of the input source is requested, the OSD menu illustrated in FIG. 2B can be displayed. The controller 105 can request a password to be input as the second password to unlock the lock function performed when changing the input sources.

The controller 105 can determine, in operation 304, whether the input second password and the first password stored in the administrator field are the same.

If the input second password and the first password stored in the administrator field are not the same, another input of a password can be requested as the second password in operation 305.

The controller 105 can determine, in operation 306, whether the input second password and the first password stored in the administrator field are the same, whenever receiving the input second password.

If the input second password and the first password stored in the administrator field are the same, the input source can be changed in operation 307, and an image produced by the updated (changed) input source can be displayed in operation 308. However, if, for example, the second user requests to receive the S-video signals (second video signals) input from the game device through the S-video connector 100-3 while watching the third video signals input from the TV through the TV tuner connector 100-4, the OSD menu requesting the second password as illustrated in FIG. 2B can be displayed to allow the second user to input a password as the second password. The controller 105 can compare the input second password and the first password stored in the administrator field. If the input second password and the first password stored in the administrator field are the same, the input source can be changed from the TV to the game device, and the updated (changed) input signal can be input to the display unit 104.

If the input second password and the first password stored in the administrator field are not the same a predetermined number of times, the controller 105 does not change the input source in operation 309 and displays the image produced by the previous input source in operation 310. For example, if the second user selects the input source change in order to receive the second video signals input through the S-video connector 100-3 while watching the third video signals input through the TV tuner connector 100-4, the OSD menu illustrated in FIG. 2B can be displayed and the second user can input a password as the second password. The controller 105 can compare the input second password and the first password stored in the administrator field and, if the input second password and the first password stored in the administrator field are not the same, the input signal can not be changed.

If the input second password and the first password stored in the administrator field are not the same, even though the display apparatus has been turned off and then on again, another password may be requested as the second password again or the image produced by the previous input source input before the display apparatus was turned off is displayed.

If the first user forgets the first password stored in the administrator field or the first password is exposed to the second user, the administrator can establish a new password as the first password.

As described above, the method and apparatus according to embodiments of the present general inventive concept can prevent users from watching inappropriate images by changing input sources only if an input password and a stored password are the same when requesting that the input sources be changed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display apparatus having a lock operation for an external input, the apparatus comprising:
a video interface unit which receives from an external source one of a plurality of input signals;
a signal processor which processes the input signal such that an image corresponding to the input signal can be displayed; and
a controller which receives and stores a first password used for setting a lock operation to be performed when changing the input signal, requests that a second password be input whenever a change of the input signal is requested, and outputs a control signal to the video interface unit to perform a change of the input signal when the input second password and the stored first password are the same.

2. The apparatus of claim 1, wherein the controller stores the first password in an administrator field that only an administrator can access.

3. The apparatus of claim 1, wherein the controller requests that another password be input as the second password up to a predetermined number of times until the input second password and the stored first password are the same whenever the change of the input signal is requested, and determines whether the input second passwords and the stored first password are the same.

4. The apparatus of claim 3, wherein the input signal is not changed if the input second password and the stored first password are not the same whenever the second password is requested.

5. The apparatus of claim 1, wherein the controller displays an image produced by a previous input signal input before the display apparatus is turned off if the input second password and the stored first password are not the same whenever the change of the input signal is requested, and whenever the display apparatus is turned off and then on.

6. The apparatus of claim 1, wherein the controller resets the first password only by an administrator.

7. A method of implementing a lock operation in a display device, the method comprising:
receiving and storing a first password that can be used when setting a lock operation to be performed when changing an input signal;
requesting that a second password be input whenever a change of the input signal is required, and determining whether the input second password and the stored first password are the same; and
changing the input signal if the input second password and the stored first password are the same, and displaying an image corresponding to the changed input signal.

8. The method of claim 7, further comprising:
requesting that another password be input as the second password up to a predetermined number of times until the input second password and the stored first password are the same, and determining whether the input second password and the stored first password are the same each time.

9. The method of claim 8, wherein the input signal is not changed if the input second password and the stored first password are not the same whenever the password is requested.

10. The apparatus of claim 8, wherein an image produced by a previous input signal input before the display apparatus is turned off is displayed if the input second password and the stored first password are not the same whenever the change of the input signal is requested and whenever the display apparatus is turned off and then on.

11. The apparatus of claim 7, wherein the storing of the first password comprises storing the first password in an administrator field that only an administrator can access.

12. The apparatus of claim 11, wherein the storing of the first password comprises resetting the first password by the administrator.

13. A display apparatus comprising:
a video interface unit to selectively receive a first video signal and a second video signal as an input signal to be displayed; and
a controller to receive a password when a change of the input signal between the first video signal and the second video signal is requested, and to control the video interface unit to change the first video signal to the second video signal as the input signal to be displayed when the password is identical to a reference password.

14. The apparatus of claim 13, further comprising:
a display unit to display an image corresponding to the input signal,
wherein the controller controls the display unit to display an OSD menu to receive the password when the change of the input signal between the first video signal and the second video signal is requested.

15. The apparatus of claim 14, wherein the OSD menu comprises:
at least one of an automatic lock selecting section, a password input section, and a reference password changing section.

16. The apparatus of claim 14, wherein the OSD menu is displayed when the display apparatus is turned off and on.

17. The apparatus of claim 14, wherein the OSD menu is displayed before the input signal is changed between the first video signal and the second video signal.

18. The apparatus of claim 14, wherein the OSD menu comprises:
a video signal source display section to display an image representing at least one of the first video signal and the second video signal; and
a password input section through which the password is inputted.

19. The apparatus of claim 14, wherein the controller receives a request signal to change the input signal between the first video signal and the second video signal and controls the display unit to display the OSD menu according to the request signal.

20. The apparatus of claim 13, wherein the video interface unit comprises a first connector to receive the first video signal and a second connector to receive the second video signal, and one of the first connector and the second connector is selected to output a corresponding one of the first video signal and the second video signal as the input signal.

21. The apparatus of claim 20, wherein the first video signal and the second video signal are one of a composite video signal, an S-video signal and a digital video signal.

22. The apparatus of claim 20, wherein the first connector is connectable to one of a PC, a game device, a TV, and a built-in memory, and the second connector is connectable to the other one of the PC, the game device, the TV, and the built-in memory.

23. The apparatus of claim 20, wherein the first connector is one of a D-sub connector, a DVI connector, and S-video connector, a TV tuner connector, and a composite connector, and the second connector is the other one of the D-sub connector, the DVI connector, the S-video connector, the TV tuner connector, and the composite connector.

24. The apparatus of claim 13, further comprising:
a scaler connected between the video interface unit and the display unit to receive the first video signal from the video interface unit and to transmit a scaled signal to the display unit when the input signal is changed to the first video signal.

25. The apparatus of claim 24, further comprising:
a video decoder to receive and decode the second video signal; and
a deinterlacer to deinterlace the decoded video signal and to output the deinterlaced video signal to the scaler,
wherein the scaler transmits the scaled signal to the display unit according to the second video signal when the input signal is changed to the second video signal.

26. The apparatus of claim 25, wherein the controller controls the scaler to output one of the first input signal and the second input signal to be displayed according to a determination of whether the password is identical to the reference password.

27. The apparatus of claim 13, wherein the controller prevents the change of the input signal between the first video signal and the second video signal when the password is not identical to the reference password or when the display apparatus is turned off and on.
